(19) United States
(12) Patent Application Publication
(10) Pub. No.: US 2006/0026522 A1
(43) Pub. Date: Feb. 2, 2006

(54) Method and apparatus for revising data models and maps by example

(75) Inventors: Per Bendsen, Copenhagen (DK); Peter Christensen, Horsholm (DK)

Correspondence Address: WESTMAN CHAMPLIN (MICROSOFT CORPORATION), SUITE 1400 - INTERNATIONAL CENTRE, 900 SECOND AVENUE SOUTH, MINNEAPOLIS, MN, 55402-3319, US

(73) Assignee: Microsoft Corporation, Redmond, WA (US)

(21) Appl. No.: 10/899,553

(22) Filed: Jul. 27, 2004

(51) Int. Cl. G06F 17/00

(52) U.S. Cl. 715/705; 715/764; 715/707; 715/708

(57) ABSTRACT

A method, computer readable medium and system are provided which implement a change in a specialized model. In the method, a change made by a user to an instance of the specialized model is detected. A potential revision, to at least one of a master model and a map used to generate the specialized model, is identified based upon the detected change. The potential revision is suggested to the user, and is automatically made if the user instructs.

### CROSS-REFERENCE TO RELATED APPLICATIONS

Reference is hereby made to the following co-pending and commonly assigned patent applications: U.S. application Ser. No. 10/860,226, filed Jun. 3, 2004, entitled “METHOD AND APPARATUS FOR GENERATING FORMS USING FORM TYPES”; U.S. application Ser. No. 10/860,225, filed Jun. 3, 2004, entitled “METHOD AND APPARATUS FOR MAPPING A DATA MODEL TO A USER INTERFACE MODEL” and U.S. application Ser. No. 10/860,306, filed Jun. 3, 2004, entitled “METHOD AND APPARATUS FOR GENERATING USER INTERFACES BASED UPON AUTOMATION WITH FULL FLEXIBILITY”, all of which are incorporated by reference in their entirety.

### BACKGROUND OF THE INVENTION

The present invention relates to the generation and revision of user interface (UI) models. More particularly, the present invention relates to methods and apparatus for revising models and maps used to generate the UI models.

In typical business software products and applications, such as enterprise resource planning (ERP) products, a large number of forms or form user interfaces are used. It is not uncommon for the number of forms which are used in conjunction with a business software application to exceed several thousand. Developing and maintaining a large number of forms has traditionally been a labor-intensive task for software developers.

As an example of a real life business application, consider Microsoft Business Solutions-Axapta®, which has close to 3,000 tables, resulting in close to 2,000 forms. Each form has to be aligned with the layout of each table from which the run-time data is bound. The forms and related form logic, such as input validation, have to be aligned whenever the table layout changes and when business logic changes. Adding to the complexity is the increasing number of different client platform technologies. The classic Windows® UI is now accompanied by the Web Browser. In the near future, personal digital assistant (PDA), cell phone, and other UI technologies will be adding to complexity.

The Internet has taught end users that they do not need a 14 day course to learn how to use an application. End users expect applications to guide them via tasks, and they expect the application to look appealing. Because more user roles are exposed to the information presented through business applications, there is an increasing demand that forms reflect the information each user needs and the tasks that each role has to achieve. All in all the demands on user experience are increasing.

Typically, the user experience and developer experience pull in opposite directions. Good user experience takes longer for an application developer to create and maintain. The vision of having an excellent user experience, and at the same time, supporting high developer productivity, can seem contradictory. This is particularly true in the area of forms generation for business applications.

Applications presenting information must provide their users with as rich an experience as possible on platforms of very diverse capabilities (ranging from rich clients running on the user's desktop, to Web clients running in the user's browser, to Pocket Digital assistants, telephony based devices, and even speech interfaces). A business architect uses his or her knowledge in business engineering to solve problems for the customer. This person is not a computer program developer, and should be protected from the intricacies of program development.

It is common for developers to experience difficulty managing a set of common styles, colors, etc. for a number of forms, pages, documents or other UIs generated using a UI model. Changing the formatting of a single instance of a page or document, which results in a change to the UI model, does not change the general formatting and is not captured afterwards and reapplied on the other instances. Since developers are frequently not specialist at revising source models and maps used to generate the UI model, it can be especially difficult for the developer to address this problem.

The present invention provides solutions to one or more of the above-described problems and/or provides other advantages over the prior art.

### SUMMARY OF THE INVENTION

A method, computer readable medium and system are provided which implement a change in a specialized model. In the method, a change made by a developer to an instance of the specialized model is detected. A potential revision, to at least one of a master model and a map used to generate the specialized model, is identified based upon the detected change. The potential revision is suggested to the user, and is automatically made if the user instructs.

Other features and benefits that characterize embodiments of the present invention will be apparent upon reading the following detailed description and review of the associated drawings.

### BRIEF DESCRIPTION OF THE DRAWINGS

FIG. 1 is a block diagram of one exemplary environment in which the present invention can be used.

FIG. 2 is a block diagram of a general mobile computing environment in which the present invention can be implemented.

FIG. 3-1 is a block diagram illustrating an example business model.

FIG. 3-2 is a block diagram illustrating an entity business model mapped to a form.

FIG. 4-1 is a block diagram illustrating a process of generating models using maps and other models.

FIG. 4-2 is a block diagram illustrating a process of generating a native control model (display target specific model) from an initial user or business model through a series of mappings.

FIG. 4-3 is a block diagram illustrating a process of the type shown in FIGS. 4-1 and 4-2 for an example embodiment.

FIG. 5 is a block diagram illustrating an example mapping process in which a business model entity is first mapped to a display target independent form, with the entity properties mapped to controls to create a display target independent logical form, and then the logical form is mapped to the display target(s).

FIG. 6 is a block diagram illustrating a process of routing changes in a specialized model back through the generation to the instance which has a correct scope for implementing the change.

FIG. 7 is a block diagram illustrating changes in a specialized model propagating back to a map.

FIG. 8 is a block diagram illustrating changes in a specialized model propagating back to a master model.

FIG. 9 is a block diagram illustrating a system configured to implement the methods of the present invention.

### DETAILED DESCRIPTION OF ILLUSTRATIVE EMBODIMENTS

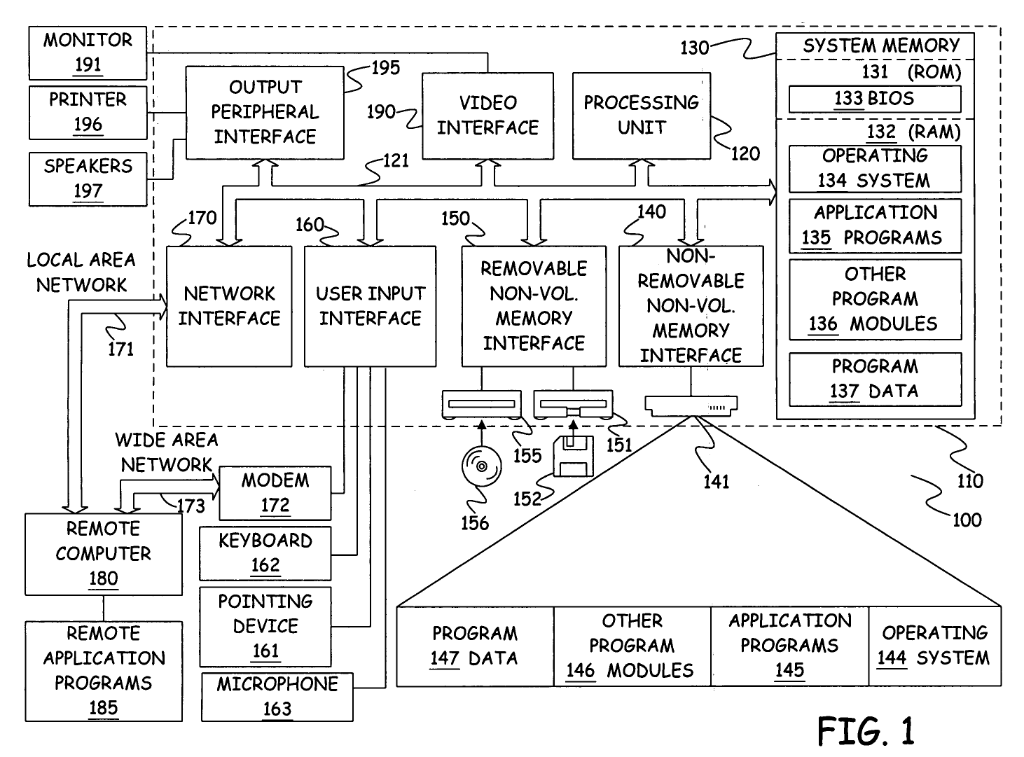

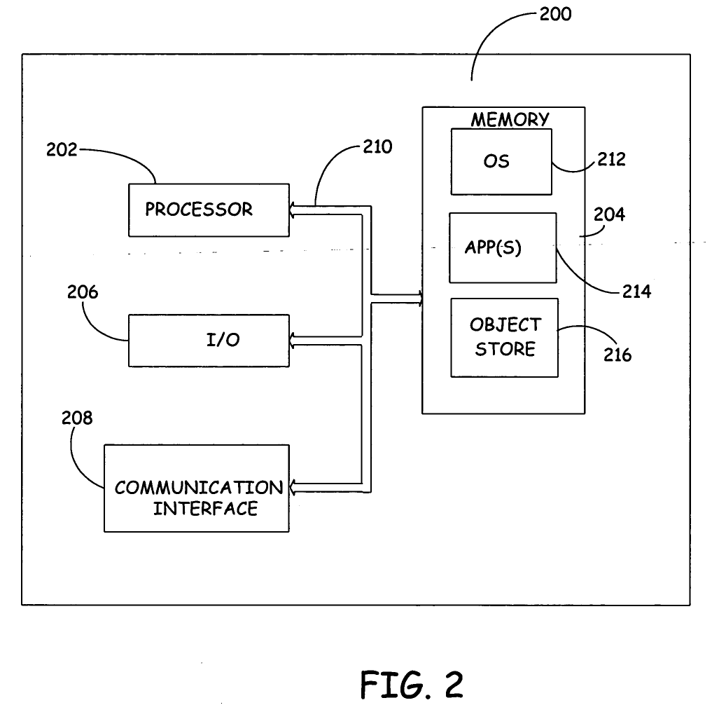

FIG. 1 illustrates an example of a suitable computing system environment 100 on which the invention may be implemented. FIG. 2 illustrates an example of a mobile device computing environment 200. The computing system environments 100 and 200 are only two examples of suitable computing environments, and are not intended to suggest any limitation as to the scope of use or functionality of the invention. Neither should the computing environments 100 and 200 be interpreted as having any dependency or requirement relating to any one or combination of components illustrated in the exemplary operating environment 100. Description of the methods and apparatus of the present invention with general reference to these computer architectures does not limit the invention to currently used computer architectures, but instead, the invention can be implemented on any suitable computer architecture, including future generations of computer architectures.

The invention is operational with numerous other general purpose or special purpose computing system environments or configurations. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, etc. that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

With reference to FIG. 1, an exemplary system for implementing the invention includes a general purpose computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137. A particular group of application programs are called business applications. These are targeted at the management of companies including—but not limited to—handling the general ledger, inventory, salaries, customers, sales, purchases, financial reports and any other data relevant for a business.

The computer 110 may also include other removable/non-removable volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1, provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies.

A user may enter commands and information into the computer 110 through input devices such as a keyboard 162, a microphone 163, and a pointing device 161, such as a mouse, trackball or touch pad. Other input devices (not shown) may include a joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). The input devices are used for creating, modifying, and deleting data. Input devices can also be used for controlling (starting and stopping) the application programs and particular functions herein. The functions include opening (showing) forms and closing the forms. A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 195. The monitor or other display device is used to show (render) forms.

The computer 110 may operate in a networked environment using logical connections to one or more remote computers, such as a remote computer 180. The remote computer 180 may be a personal computer, a hand-held device, a server, a router, a network PC, a peer device or other common network node, and typically includes many or all of the elements described above relative to the computer 110. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 1 illustrates remote application programs 185 as residing on remote computer 180. It will be appreciated that the network connections shown are exemplary and other means of establishing a communications link between the computers may be used.

FIG. 2 is a block diagram of a mobile device 200, which is an alternative exemplary computing environment. Mobile device 200 includes a microprocessor 202, memory 204, input/output (I/O) components 206, and a communication interface 208 for communicating with remote computers or other mobile devices. In one embodiment, the afore-mentioned components are coupled for communication with one another over a suitable bus 210.

Memory 204 is implemented as non-volatile electronic memory such as random access memory (RAM) with a battery back-up module (not shown) such that information stored in memory 204 is not lost when the general power to mobile device 200 is shut down. A portion of memory 204 is preferably allocated as addressable memory for program execution, while another portion of memory 204 is preferably used for storage, such as to simulate storage on a disk drive.

Memory 204 includes an operating system 212, application programs 214 as well as an object store 216. During operation, operating system 212 is preferably executed by processor 202 from memory 204. Operating system 212, in one preferred embodiment, is a WINDOWS® CE brand operating system commercially available from Microsoft Corporation. Operating system 212 is preferably designed for mobile devices, and implements database features that can be utilized by applications 214 through a set of exposed application programming interfaces and methods. The objects in object store 216 are maintained by applications 214 and operating system 212, at least partially in response to calls to the exposed application programming interfaces and methods.

Communication interface 208 represents numerous devices and technologies that allow mobile device 200 to send and receive information. The devices include wired and wireless modems, satellite receivers and broadcast tuners to name a few. Mobile device 200 can also be directly connected to a computer to exchange data therewith. In such cases, communication interface 208 can be an infrared transceiver or a serial or parallel communication connection, all of which are capable of transmitting streaming information.

Input/output components 206 include a variety of input devices such as a touch-sensitive screen, buttons, rollers, and a microphone as well as a variety of output devices including an audio generator, a vibrating device, and a display. The devices listed above are by way of example and need not all be present on mobile device 200. In addition, other input/output devices may be attached to or found with mobile device 200.

Models and Maps

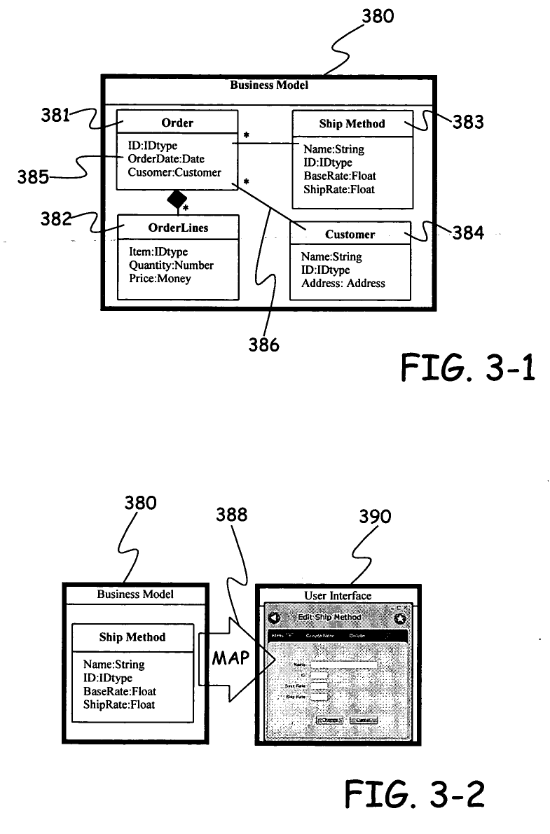

Many information systems use models. Examples of models include: object diagrams, Extensible Markup Language (XML) schemas, database definitions, and form definitions. A model is formally defined as a set of objects, each of which has properties, compositions, and associations. In business UIs, the control hierarchies used to render the forms can be regarded as models, such as Windows control trees and Hypertext Markup Language (HTML) object models. Also, models can be used to define the business data, using for example Unified Modeling Language (UML) diagrams and class definitions. In an example framework, applications are modeled using business entities. Thus, the business model consists of these business objects called entities, relations between entities, and properties on the entities. See for an example of a simple model 380 the entities 381, 382, 383 and 384 shown in FIG. 3-1. The entities have properties (see for example properties 385 of entity 381) and relationships with other entities (see for example relationship 386 between entities 381 and 384).

When a model is transformed into another model, a map is used explicitly, or sometimes implicitly. Maps describe the relationships between models. Some examples of mappings include: Extensible Stylesheet Language Transformation (XSLT) which is intended to map XML to XML; controls which are used to render an object model on a specific device surface; mappings of orders from one application to another; and Computer Aided Software Engineering (CASE) tools which map UML to class definitions.

Generally, maps can be imperative or declarative in nature. For example, in current business applications, maps are mostly programmed using object-at-a-time mappings, meaning that mappings are coded as “switch” statements in code, which take a particular object as input and return another object. Thus, conventional business applications typically use imperative maps, maps written in the code of a typical programming language.

Declarative maps can be explicitly or implicitly defined. For explicitly defined maps, the explicit nature of the maps means that the maps are external to the generation engine used to do the mapping or rendering, and that the maps are themselves models. Stated another way, the explicit nature of the maps means that they are defined separately from the controls and the forms. Conventionally, this mapping has been done implicitly inside the controls code or forms code.

The declarative nature of the maps means that the maps are not imperative (coded in a typical programming language). As used herein, the phrase “declaratively defined” means that the maps are not just defined in code as has conventionally been the case, but they are defined in a format which allows the maps to easily be changed. Examples of a declaratively defined format include, but are not restricted to, XML documents, comma-separated files, BizTalk Maps (mapping one data schema to another), and MBF Entity Maps (mapping an object model to a database schema).

The present invention can be used with imperative or declarative maps, and with those maps being defined explicitly or implicitly. Because imperative maps are more difficult to change than are declarative maps, when implementing the disclosed model by example concepts when an imperative map is used, the present invention is typically used to modify the data models and not the maps. When declarative maps are used, the present invention can also more readily be used to modify data models and/or maps. The present invention can also be used with maps that are a combination of imperative and declarative. The following examples are, however, described primarily with reference to declarative and explicit maps. It must be noted that the present invention is not limited by these particular examples.

Model-Driven UI Based on Maps

Having the application model is an important feature when generating the UI for a business application. A large majority of the UI can be generated solely based on the model of the business logic and maps. When an application developer has modeled a new entity, the UI is derived from this. This is illustrated diagrammatically in FIG. 3-2 which illustrates business model 380 being mapped (as shown at 388) to a UI model 390. Arrow 388 represents the mapping process, as well as a suitably configured mapping engine which uses a map to conduct the mapping process.

Although this mapping can be achieved using traditional imperative coding techniques, the mapping is not as straightforward if certain challenges are to be met. The challenge is that when new property types are created and used in an entity, the coded transformation might not know how to handle the new type and the transformation therefore has to be modified and re-compiled. Another challenge is handling newly developed controls that will only be of value if they are included in the transformation—again this results in re-programming the transformation. The mapping techniques of the present invention do not utilize traditional coding techniques (i.e., they are declarative instead of imperative), and are able to meet these challenges. The platform used in the example embodiments exposes a layered UI model, and uses maps to transform models from one layer to another. This is described below in greater detail.

The invention builds upon the mapping of models onto other models, working from a very abstract model (describing the business entities to interact with) to a concrete model (specifying exactly which device specific control should be used to render the business information). In general, this mapping may involve any number of steps.

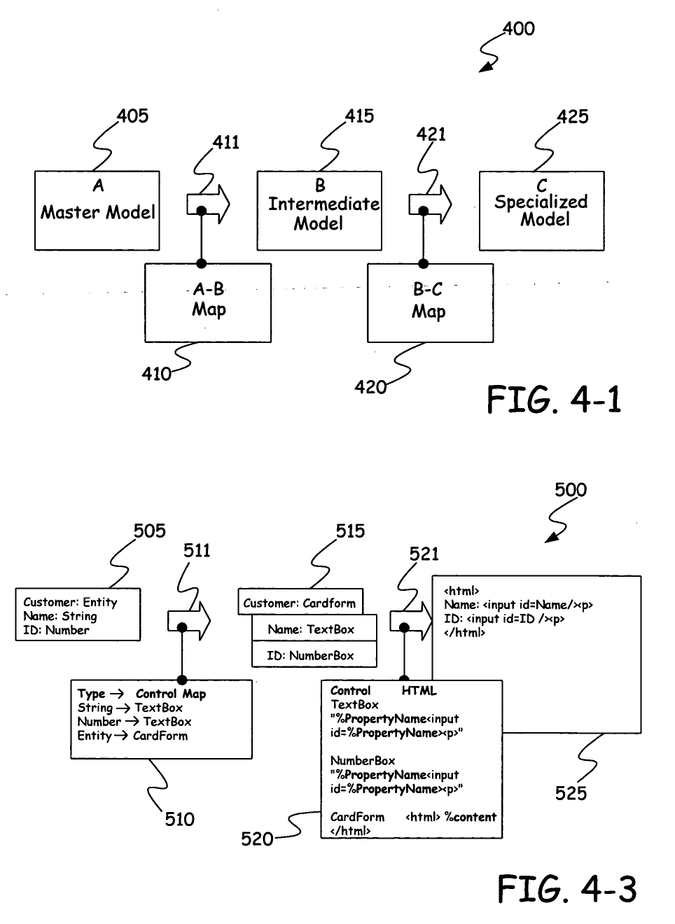

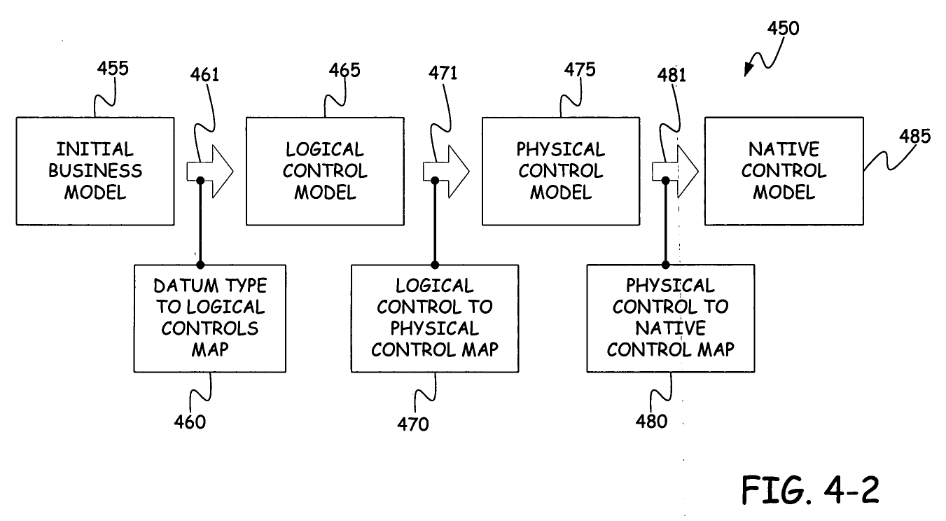

For example, consider the block diagram 400 shown in FIG. 4-1 which illustrates a process of mapping from a master model 405 to a specialized model 425 using two explicit and declarative mapping steps. Master model 405 (i.e., “model A”) can be, for example, a database, table, entity, object, or other types of models in a problem domain specific to a user. Master model 405 is mapped to an intermediate model 415 (i.e., “model B”) with the mapping step illustrated at 411 using a map 410 (i.e., “A-B map”). Intermediate model 415 can be a display target independent model having logical controls, as will be described below in greater detail. Intermediate model 415 is then mapped to a specialized model 425 (i.e., “model C”) with the mapping step illustrated at 421 using a second map 420 (i.e., “B-C map”). Specialized model 425 can be a display target specific model having physical controls, as will also be described below in greater detail. The arrows used to represent mapping steps 411 and 421 also represent one or more mapping engines which are configured to utilize maps 410 and 420 to implement the mapping steps.

In accordance with some embodiments, the mapping scheme involved in determining how to allow the user to interact with business information on the client platform involves at least three steps, as described below and as shown diagrammatically in block diagram 450 of FIG. 4-2. The initial model 455 (see also master model 405 shown in FIG. 4-1) contains information about the business entities that the user must interact with. Each datum of this model is of a particular type. The first step involves determining which logical control to employ for a given type (string, integer, decimal type representing monetary values, addresses containing other values etc) of datum to present.

The logical control to use for the given type is determined using a mapping from data type in model 455 onto logical control in model 465. The mapping process is illustrated at 461, and utilizes a map 460 (i.e., the “datum type to logical control map”). Logical controls have several useful properties. They are completely free from dependencies to any specific display target, but hold properties that govern the behavior of device specific physical controls. The lookup of the logical control is performed taking the type hierarchy into account. If no logical control is specifically suitable for encapsulating the properties of a specific type, the search continues with a base type, until a logical control is found to handle the type.

Once a logical control has been identified from the type of data to be presented, the physical control used to actually perform the rendering on the given platform must be found. This is done using another mapping, yielding the physical control from the logical control and the display target. The mapping process is illustrated at 471, and uses map 470 (i.e., the “logical control to physical control map”) to generate physical control model 475 from logical control model 465.

When the client runs on the user's display target, the physical control will be used to create instances of the native controls used to interact with the user. This is done by a third mapping, yielding a set of native controls from the physical control. For instance, if the physical control was an address control, the physical control would map onto native controls for street, city, country. The mapping process is illustrated at 481, and uses map 480 (i.e., the “physical control to native control map”) to generate native control model (or display target specific model) 485 from physical control model 475. Again, arrows 461, 471 and 481 also represent the mapping engine(s) used to implement the mapping functions as specified by maps 460, 470 and 480.

The mapping described above may be augmented with other mappings to achieve the desired result. Other factors include the type of form rendered (card or list view), the user role (possibly restricting the information offered to the user). The process of arriving from the abstract model to the concrete model is purely prescriptive (by describing the mappings involved), and flexibility is afforded by being able to change these mappings. The present invention can be used to effect changes in upstream models and/or maps, to reflect changes to a downstream model regardless of how many mapping steps have been employed.

As another example, FIG. 4-3 illustrates a block diagram 500 showing a mapping process for getting from a customer's name and identification number (ID) to the HTML used to render this information in a browser. In this example, a model of business data (a UML model) 505 is mapped to a display target independent UI model 515, which again is mapped to display target specific model formats (HTML, XAML, WinForms, WML) 525. While other model formats can be used, in FIG. 4-3 the display target specific model format is HTML.

The master or initial business model 505 is an entity (or object) or class of entities (or class of objects) having the customer's name and ID as properties. The “Name” and “ID” properties of model 505 are of types “String” and “Number”, respectively. Model 505 is mapped to a logical control layer of model 515 using a prescriptive map 510. The mapping process is represented at 511. In this example, the data type “String” is mapped to a “TextBox” logical control, while the data type “Number” is mapped to a “NumberBox” logical control. The type of form is also generated via the map. In this example, the “Entity” is mapped to a “Card Form”.

Next, logical control model 515 is mapped to an HTML model 525 using map 520. The mapping process is represented at 521. In this example, model 525 is a physical control model in the form of an HTML model. Thus, map 520 maps the logical controls of model 515 to HTML tags or elements in model 525. HTML model 525 is then used to render the information from model 505 in a browser. Again, the arrows used to represent mapping steps 511 and 521 also represent suitably configured mapping engines which utilize maps 510 and 520 to implement the mapping process.

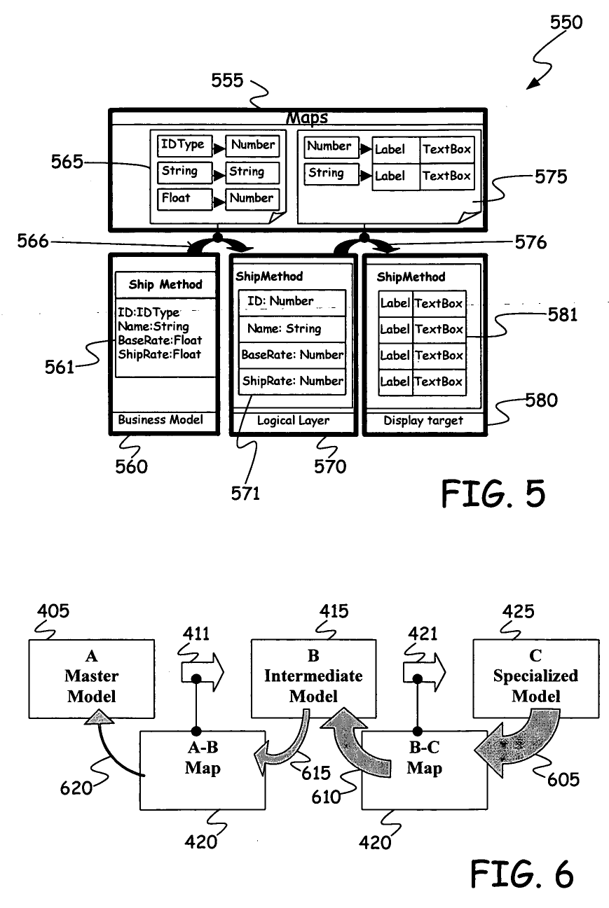

FIG. 5 illustrates a further aspect in which several different property types can be mapped to the same final controls, so the number of required controls does not necessarily increase when the number of property types increases. As shown in the block diagram of FIG. 5, a business model 560 having properties 561 of different types is mapped to a display target model 580 using maps 555. Similar to previously discussed examples, model 560 is mapped to a logical layer model 570 having logical controls 571. The mapping engine and mapping process, which use map 565, are illustrated at 566. Map 565 maps the datum types (“IDType”, “String” and “Float”) of the properties 561 of model 560 to logical controls (“Number” and “String”). In this case, both the “IDType” and “Float” datum types map to the “Number” logical control type, while the “String” datum type maps to the “String” logical control type.

Next, logical layer model 570 is mapped to display target model 580 having physical controls 581 specific to a particular display target. Model 570 is mapped to model 580 using map 575, with the process and mapping engine represented at 576. Map 575 maps the logical control types “Number” and “String” of model 570 to the physical control type “TextBox” of model 580, illustrating again that several different types from a particular model can be mapped to a single type on another model. By extension, several different property types from a business model can be mapped to the same final (for example “physical”) control.

The Mapping Language

In some examples, which do not limit the scope of the present invention, mapping uses a simple declarative mapping language which is extensible. Mapping takes one or more tokens as input and returns one or more tokens as output. Given a property type as input, one or more logical controls can be specified as output. In these embodiments, it must also be possible to specify the output as null. For example, the “IDType” could be a computer generated field, which the user cannot edit, in which case the type maps to nothing. Also, the mapping can control parameters on the output. For example, the “String” property could result in a wider TextBox compared to the other TextBoxes on the form. The mapping can also be controlled by parameters on the input. For example, a long “string” property could result in a special multi-line TextBox.

To handle the scoping problem addressed earlier, a scope condition is needed—on the previously discussed example form, “IDTypes” map to “IDControls”, but on all other forms a “Number” control is used. Other parameters can also be used as scope, including the business entity, the entity stereotype, the form type, etc. There are other conditions which it would be beneficial to take into consideration when a maps is to be performed. One example is the parent control. If the parent control is a list, an enumerator logical control might choose to map (in a logical control to physical control map) to a drop-down physical control and not a radio button physical control. Another condition could be the number of possible selections in the enumerator; radio buttons could be used if there are two or three, but more choices could result in a list. Going down this road, the mapping language will end up being very complex compared to the initial requirement, and another abstraction level on top of the map is needed for developers to understand the maps. This pattern has been seen with Extensible StyleSheet Language Transformations (XSLT), where several tools have been implemented to hide the complexity.

Model By Example

As noted, it is common for developers to experience more difficulties managing more abstract source models and maps than managing and modifying the specialized target models. However changing the specialized models when they have been generated presents some challenges. Changing the formatting of a single instance of a page or document, which results in a change to the UI model, does not change the general formatting and is not captured afterwards and reapplied on the other instances. Since developers are frequently not specialist at revising source models and maps used to generate the UI model, it can be especially difficult for the developer to address this problem.

A solution to this problem in accordance with embodiments of the present invention is based on having highly abstract models map, in one or more steps as illustrated above, to other more specific models. When changes are made to a generated model (for example model B 415 or model C 425 in FIG. 4-1), the changes are captured and either:
i) Changes in either or both of the maps which have been used in the transformation (A-B map 410 and B-C map 420) are suggested;
ii) Changes are suggested in the master (or upstream) model (model A or B); or
iii) An inquiry is made as to whether the change is intended only to be available in the specific generated model.

This concept is illustrated diagrammatically in FIG. 6. When a change is detected in a generated model, for example specialized model 425, the systems and methods of the present invention identify potential revisions or modifications to an “upstream” model such as intermediate model B 415 (i.e., a model used in the generation of the generated model C 425), and/or potential revisions to a map used in the transformation such as B-C map 420. These suggested changes, as well as the changes themselves if the user elects to make the changes, are illustrated in FIG. 6 by arrows 605, 610, 615 and 620. Changes in the specialized model are routed back through the generation to the instance which has the correct scope, for example back to master model A 405. Note that model B 415 is a generated model, but also serves as the master model for model C 425. Thus, if a detected change in model C 425 results in the suggestion and approval of a change to model B 415, the process can be repeated to suggest and make changes to model A 405 based upon the changes to model B 415.

The developers' or designers' user experience is a key driver for using the model by example concepts of the present invention. Often a map or a general model is perceived as complex and difficult to understand because the model formats are different than the formats used in the final rendering which the user sees. The final format often has strong tool support which is frequently not the case for more abstract formats. The ways that the maps are applied to the model might also be complex and they might even be hidden for the user. The side effects of changing a map are difficult to find and manage. On the other hand it seems easy to change a single instance; the resulting changes are inherently clear and the scope is limited to the single instance.

If the changes suggested using the present invention are inspected, the user can further benefit by learning where changes could have been made, which increases the user understanding of the system. The present invention also provides the potential for increasing productivity. If a specific change is to be made in many specialized models, the change can be captured and applied to many forms or maps used to generate the specialized models. Further, by propagating changes back into the master model, or into the maps used for generation, the master model can be modified and the dependant models can be re-generated with out loss of work. The present invention also provides the opportunity for creating more uniform products. When the more general models and maps are changed, the generated models will all have the changes applied to them.

The present invention is used in various environments in which a specialized model has been generated based on another model and a map. If changes are made to the specialized model, an analysis of the change is made. Although FIGS. such as FIGS. 4-1 and 6 label models as master, intermediate and specialized, it should be understood that any model which is used along with map to generate another model can be considered a master to the generated model, while the generated model can be considered a specialized instance or model to the master. Example methods of detecting the changes to a specialized model are described below, though any acceptable method can be employed.

Several situations can be the result of the analysis which identifies or detects changes in the specialized model. These are described as follows:

1. Change a Map

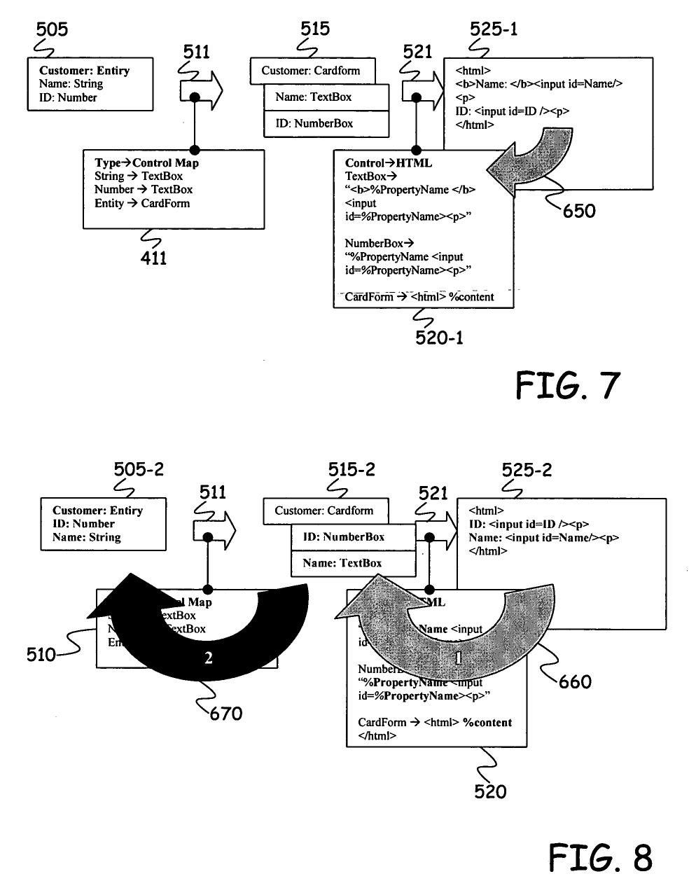

If the change can be traced to be strictly modifying the result of a map entry, systems and methods of the present invention can be configured to suggest that the map be changed. As an example, consider the scenario illustrated in FIG. 7 in which specialized model 525-1 has been changed or modified relative to specialized model 525 shown in FIG. 4-3. In this example, in model 525-1 the “Name” field or property is bolded by using the appropriate html tags, “<b>Name:</b>”. Here the method and system of the present invention can suggest to the user, for example through prompting, that the map 520 be changed to map 520-1 to include the mapping “TextBox”→“<b>% PropertyName</b> . . . ”. This suggestion, as well as the resulting change if the user selects to do so, is represented in FIG. 7 by arrow 650.

The changes in the model can both be made in a text editor or in a WYSIWYG (“what you see is what you get”) editor such as Microsoft Frontpage®, which is used to generate HTML pages. If the Master Model is changed afterwards the generated model will still have the change. Attention should be on the possible side effects; other generated models will also have this new mapping characteristic—it is therefore recommended that the user is prompted before making this type of change.

2. Change a Model

Changes in the specialized model can also be traced back to the master model as a preferred method of implementation. In this case, it follows that it is suggested that the master model is changed accordingly. Again it is only suggested, and the user has to decide whether the change only should stay in the local scope (i.e., only in the particular instance of the modified specialized model) or whether the master model should be changed.

As an example, consider the scenario illustrated in FIG. 8 in which specialized model 525-2 has been changed or modified relative to specialized model 525 shown in FIG. 4-3. In this example, in model 525-2, the Name and Id change place in the html. In this instance, while this change could be implemented by modifying map 520, the system and method suggest that the intermediate model 515 be changed to intermediate model 515-2 having the corresponding controls reversed in order as well. This suggestion, as well as the resulting change if the user selects to do so, is represented in FIG. 8 by arrow 660. Note that changes in this intermediate model can result in changes in the previous maps or models as well (i.e., changes from master model 505 to master model 505-2). This suggestion, as well as the resulting change if the user selects to do so, is represented in FIG. 8 by arrow 670.

3. Change Model or Map

Changes can be traced to both a map and a model. This case is a special borderline case where both can work depending on what the user actually is trying to achieve. It is suggested that both solutions are presented to the user, and that the user choose. In an example, the complete ID section could be removed from the intermediate model 515 or from the specialized html model 525. Once this is detected, the user is prompted by the system with alternative changes which can be made. In this case, the user has to decide whether this change results in the map 520 being modified such that the “NumberBox” map entry maps to nothing, or whether the ID should be completely removed from the master model (in this case model 505).

4. No Propagated Changes

There will be cases were changes cannot be traced to the models or maps, and it is therefore an option to not suggest changes at all. In this case, the model is stored as it is, and after changes to maps and master models—which would have affected the generated model—the user is prompted to solve the inconsistency by either regenerating the models or by keeping the modified model and manually updating models if necessary. It is expected that these types of changes are limited as they do not seem to have a lot of value.

As an example, consider the scenario where the ID text is moved up above the Name text in the generated HTML model 525. This change is neither traced to a map or model—but it is also an unlikely scenario.

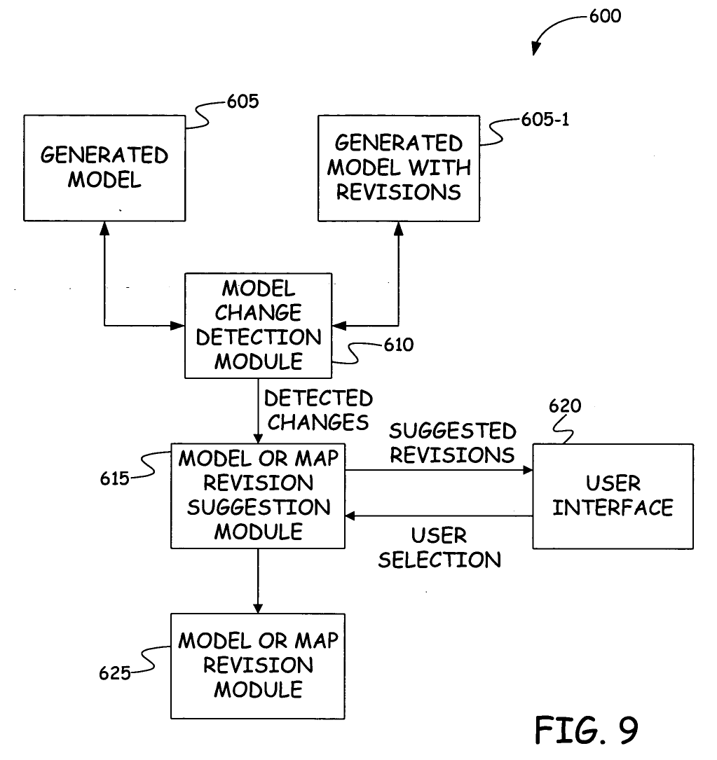

Referring now to FIG. 9, shown is a system 600 which can be used to implement the concepts and methods described above. In this illustration of system 600, a generated model 605 (i.e., a specialized model) is revised or changed resulting in a generated model with revisions 605-1. A model change detection module or component 610 compares the model instances 605 and 605-1 to detect changes or identify differences. The model change detection component 610 can use any of a variety of techniques to detect the changes between the models 605 and 605-1. For example, component 610 can implement a property by property comparison of models 605 and 605-1. Component 610 can also be configured to implement model management algebra, such as those described by Philip A. Bernstein in the paper “Applying Model Management to Classical Meta Data Problems”, Proceedings of the 2003 CIDR Conference (2003), to identify differences between the models.

Based upon the detected changes, revision suggestion module or component 615 identifies potential revisions, to maps or master models, which would cause the change in future regenerations of the specialized model. Again, any of a variety of techniques can be used to identify potential master model or map revisions. For example, the module 615 can use an iterative trial and error approach of modifying a master model or map in an attempt to achieve the desired change in the generated model. The trial and error approach can be implemented automatically, or with the assistance of user prompts and feedback. In the alternative, the model management algebra described in the above-listed Philip Bernstein paper can be used. Still other techniques can be used as well.

In exemplary embodiments of the invention, changes to a master model or map are only made with the permission of the user. Thus, component 615 suggests potential revisions to the user through a UI 620, and the user provides a selection input back to component 615 also through the user interface. Then, a model or map revision module or component 625 implements the suggested changes to the master model or map. To test the changes, the model 605 is regenerated using the master model and map (with at least one of the two having been revised), and a comparison is again made between regenerated model 605 and revised model 605-1. If the suggested and accepted changes to the master model and/or map worked, model change detection component 610 should detect no differences between the two.

Although the present invention has been described with reference to particular embodiments, workers skilled in the art will recognize that changes may be made in form and detail without departing from the spirit and scope of the invention.

What is claimed is:

1. A method of implementing a change in a specialized model, the method comprising:
detecting a change made by a user to an instance of the specialized model; and
identifying a potential revision, to at least one of a master model and a map used to generate the specialized model, based upon the detected change.

2. The method of claim 1, and further comprising suggesting to the user the revision to the at least one of the master model and the map used to generate the specialized model.

3. The method of claim 2, and further comprising receiving an input from the user which is indicative of whether the suggested revision is to be made to the at least one of the master model and the map.

4. The method of claim 3, and further comprising automatically revising the at least one of the master model and the map if the received input from the user is indicative of an instruction to make the suggested revision.

5. The method of claim 4, and further comprising:
regenerating the specialized model using the master model and the map, at least one of which having been revised; and
comparing the regenerated specialized model to the instance of the specialized model having the change.

6. The method of claim 1, and wherein if the map used to generate the specialized model is an imperative map, then the step of identifying the potential revision, to at least one of the master model and the map used to generate the specialized model, based upon the detected change further comprises identifying the potential revision to the master model.

7. The method of claim 1, wherein the specialized model is a logical control model, and wherein the step of identifying the potential revision, to at least one of the master model and the map used to generate the specialized model, based upon the detected change further comprises identifying the potential revision in at least one of a business model and a datum type to logical control map.

8. The method of claim 1, wherein the specialized model is a physical control model, and wherein the step of identifying the potential revision, to at least one of the master model and the map used to generate the specialized model, based upon the detected change further comprises identifying the potential revision in at least one of a logical control model and a logical control to physical control map.

9. The method of claim 1, wherein the specialized model is a native control model, and wherein the step of identifying the potential revision, to at least one of the master model and the map used to generate the specialized model, based upon the detected change further comprises identifying the potential revision in at least one of a physical control model and a physical control to native control map.

10. The method of claim 1, and further comprising identifying whether the change made by the user should be stored in the specialized model.

11. The method of claim 1, wherein identifying the potential revision to at least one of the master model and the map used to generate the specialized model further comprises identifying the potential revision only to the map.

12. The method of claim 1, wherein identifying the potential revision to at least one of the master model and the map used to generate the specialized model further comprises identifying the potential revision only to the master model.

13. A computer-readable medium containing computer-executable instructions for implementing the method of claim 1.

14. A system for implementing a change in a generated specialized model, the system comprising:
a model change detection component configured to compare an instance of the generated specialized model to a changed specialized model to detect a change made by a user to the instance of the generated specialized model; and
a revision suggestion component configured to identify a potential revision, to at least one of a master model and a map used to generate the generated specialized model, based upon the detected change.

15. The system of claim 14, wherein the revision suggestion component is further configured to suggest to the user the revision to the at least one of the master model and the map used to generate the specialized model.

16. The system of claim 15, wherein the revision suggestion component is further configured to receive an input from the user which is indicative of whether the suggested revision is to be made to the at least one of the master model and the map.

17. The system of claim 16, and further comprising a revision component configured to automatically revise the at least one of the master model and the map if the received input from the user is indicative of an instruction to make the suggested revision.

18. The system of claim 14, and wherein if the map used to generate the generated specialized model is an imperative map, then the revision suggestion component is configured to identify the potential revision to the master model.

19. The system of claim 14, wherein the revision suggestion component is configured to identify the potential revision only to the map.

20. The system of claim 14, wherein the revision suggestion component is configured to identify the potential revision only to the master model.
